(19) United States
(12) Patent Application Publication
(10) Pub. No.: US 2025/0361954 A1
(43) Pub. Date: Nov. 27, 2025

(54) Bidirectional circular tube fixing bracket

(71) Applicant: Qiusheng Mai, Chaozhou (CN)

(72) Inventor: Qiusheng Mai, Chaozhou (CN)

(21) Appl. No.: 18/673,790

(22) Filed: May 24, 2024

(51) Int. Cl. F16L 3/10

(52) U.S. Cl. CPC F16L 3/1091

(57) ABSTRACT

The invention provides a bidirectional circular tube fixing bracket relating to technical field of pipe fittings, including a first half bracket, a second half bracket, and a fixing base disposed middle position outside the first half bracket, first half arc grooves are provided at inner side of the first and second half bracket; the invention clamps and fixes circular tubes through the connection between first and second half brackets by fasteners, implements the adaptive fixation of circular tubes in the first direction through the first clamping groove composed of first half arc grooves on the inner side of the first and second half bracket, and the adaptive fixation of circular tubes in the second direction through the second clamping groove composed of second half arc grooves on the inner side of the first and second half bracket, that is, bi-directional adaptation, thus expanding the adaptive installation size.

### TECHNICAL FIELD

The invention relates to the technical field of pipe fittings, particularly to a bidirectional circular tube fixing bracket.

### BACKGROUND

Circular tube refers to a steel material with two open ends and a hollow concentric cross-section, with a large ratio of length to perimeter. It can be used for pipelines, thermal equipment, mechanical industry, petroleum geological drilling, containers, chemical industry, and special purposes. The specifications of a circular tube are represented by external dimensions (such as outer diameter or edge length), inner diameter, and wall thickness, covering a wide size range, from small diameter capillary tubes to large circular steel pipes with a diameter of several meters;

During use, fix circular tubes are often fixed by fixing brackets. Existing fixing brackets, generally of clamp type structure, clamp circular tubes with two half clamps and fix circular tubes from both sides through installed screws. Clamp type brackets can only clamp the circular tube unidirectionally through a unidirectional clamping groove, and have a limited adaptation size. Therefore, the invention proposes a bidirectional circular tube fixing bracket to solve the existing problems in the prior art.

### SUMMARY

In response to the above problems, the invention proposes a bidirectional circular tube fixing bracket that adapts to circular tubes, expands the fitting size for installation, and has a wide range of applications.

The invention achieves the purposes through the following technical solutions: a bidirectional circular tube fixing bracket includes a first half bracket, a second half bracket, and a fixing base that is disposed at a middle position on the outer side of the first half bracket, first half arc grooves are provided at the inner side of the first half bracket and the second half bracket, and the half arc grooves of the first half bracket and the second half bracket are matched to form a first clamping groove;
second half arc grooves are provided on the two ends at the inner side of the first half bracket and the second half bracket, and the second half arc grooves of the first half bracket and the second half bracket are matched to form a second clamping groove, rubber teeth are provided on the inner side of the first half arc groove and the second half arc groove, and the first half bracket and the second half bracket are connected by fasteners.

Further improvement: a first fixing hole is provided at all four corners inside the first half bracket, and a second fixing hole is provided at all four corners inside the second half bracket.

Further improvement: the fastener includes a screw and a nut, and the screw is used to penetrate the first fixing hole and the second fixing hole and is fixed by the nut (9).

Further improvement: a sleeve block is provided at the middle position on the outer side of the first half bracket, a sleeve cover is provided on one side of the fixing base, and the sleeve cover is disposed on the outer side of the sleeve block.

Further improvement: a first mounting hole is provided at the middle position on one side of the sleeve block, a second mounting hole that passes through the fixing base is provided at the middle position inside the sleeve cover, and the first mounting hole and the second mounting hole are fixed internally by screws.

Further improvement: a positioning hole is provided at the edge of one side of the sleeve block, and a positioning block is provided at the inner edge of the sleeve cover, and the positioning hole is adapted to the positioning block.

Further improvement: a base hole is provided on the fixing base, and the base hole is used to fix gasket and screws on the installation base surface.

The beneficial effects of the invention are presented below:
1. The invention realizes the clamping and fixation of circular tubes through the connection between the first half bracket and the second half bracket by fasteners, implements the adaptive fixation of circular tubes in the first direction through the first clamping groove composed of the first half arc grooves on the inner side of the first half bracket and the second half bracket, and the adaptive fixation of circular tubes in the second direction through the second clamping groove composed of the second half arc grooves on the inner side of the first half bracket and the second half bracket, that is, the bi-directional adaptation, thus expanding the adaptive installation size with wide applications.
2. In the invention, a fixing base is installed on the first half bracket and is fixed on the installation base surface through a base hole, gaskets, and screws, so that the position of the clamped circular tube can be fixed, and the installation by screws allows to remove the fixing base from the first half bracket and adapt the positioning hole with positioning block, and to install and fix the fixing base after direction regulation, adapting to different installation bases in different directions.

### BRIEF DESCRIPTION OF DRAWINGS

FIG. 1 is the main view of the present invention;

FIG. 2 is a schematic diagram of the disassembly of the present invention;

FIG. 3 is a structural diagram of the installed fixing base of the present invention.

Where: 1. First half bracket; 2. Second half bracket; 3. Fixing base; 4. First half arc groove; 5. Second half arc groove; 6. First fixing hole; 7. Second fixing hole; 8. Screw; 9. Nut; 10. Sleeve block; 11. Sleeve cover; 12. First mounting hole; 13. Second mounting hole; 14. Screw; 15. Positioning hole; 16. Positioning block; 17. Base hole.

### DESCRIPTION OF EMBODIMENTS

In order to deepen the understanding of the present invention, the present invention will be further elaborated below in conjunction with embodiments. The embodiment is only used to explain the present invention and does not constitute any restriction on the protection scope of the present invention.

### Embodiment 1

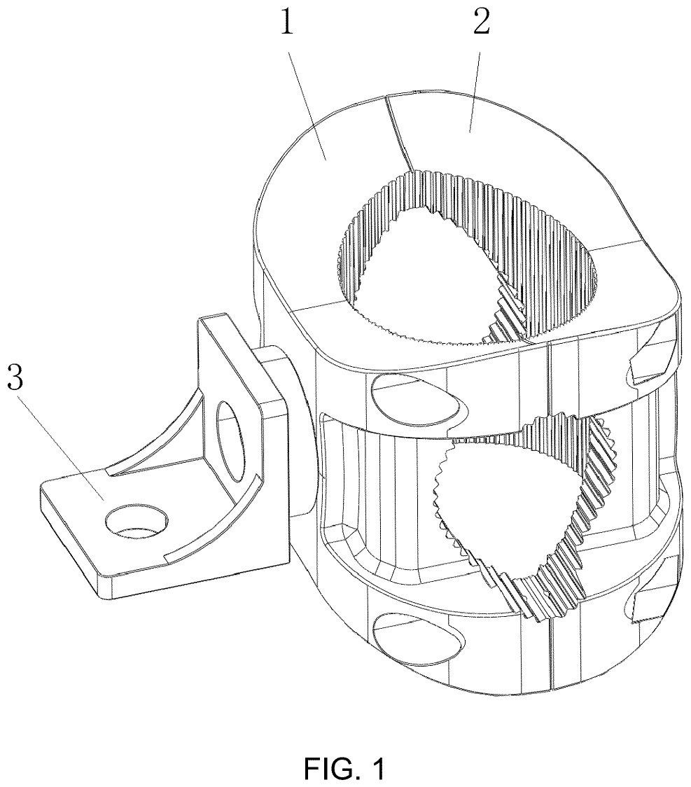

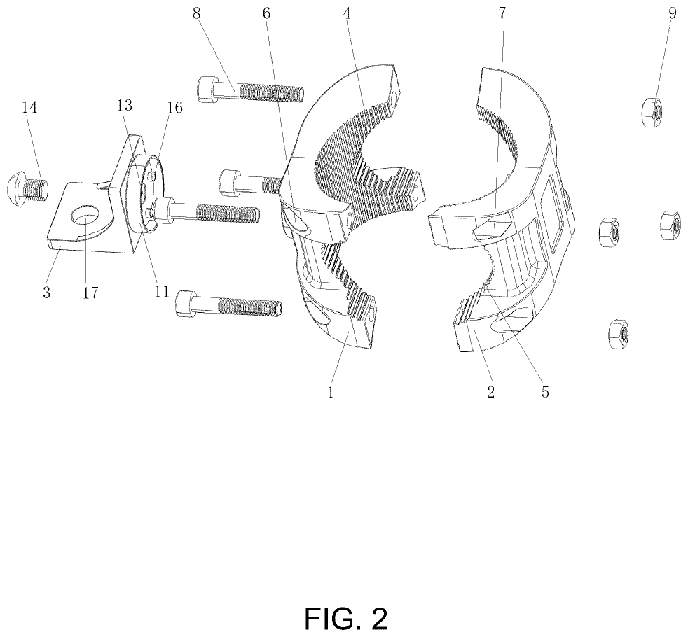

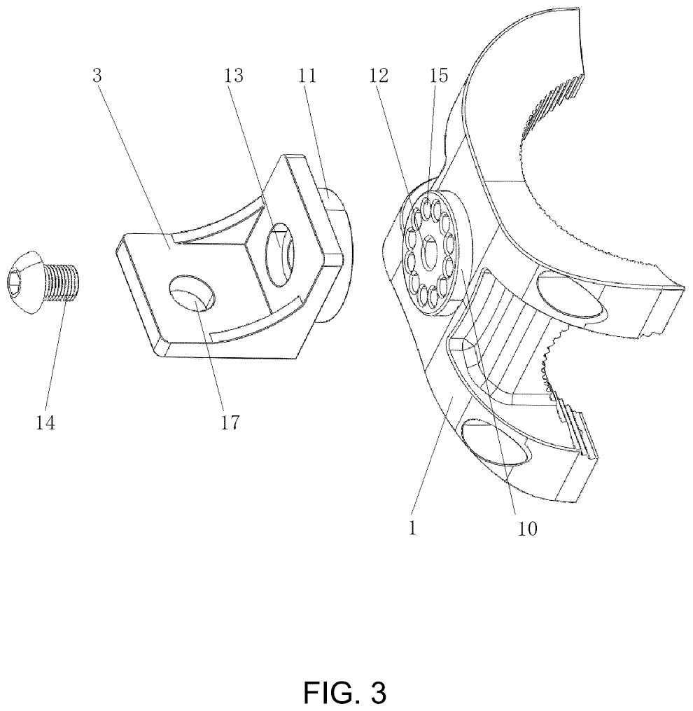

According to FIGS. 1, 2, and 3, the embodiment proposes a bidirectional circular tube fixing bracket, including a first half bracket 1, a second half bracket 2, and a fixing base 3, wherein the fixing base 3 is disposed at a middle position on the outer side of the first half bracket 1, and first half arc grooves 4 are provided on the inner side of the first half bracket 1 and the second half bracket 2, and the first half arc grooves 4 of the first half bracket 1 and the second half bracket 2 are matched to form the first clamping groove;
second half arc grooves 5 are provided at both ends on the inner side of the first half bracket 1 and the second half bracket 2, and the second half arc grooves 5 of the first half bracket 1 and the second half bracket 2 are matched to form the second clamping groove, rubber teeth are provided on the inner side of the first half arc groove 4 and the second half arc groove 5, and the first half bracket 1 and the second half bracket 2 are connected by fasteners. During use, the invention realizes the clamping and fixation of circular tubes through the connection between the first half bracket 1 and the second half bracket 2 by fasteners, implements the adaptive fixation of circular tubes in the first direction through the first clamping groove composed of the first half arc grooves 4 on the inner side of the first half bracket 1 and the second half bracket 2, with an adaptive size of 1.5-2 inch, and the adaptive fixation of circular tubes in the second direction through the second clamping groove composed of the second half arc grooves 5 on the inner side of the first half bracket 1 and the second half bracket 2, with an adaptive size of 1.5-2 inch, that is, the bi-directional adaptation, thus expanding the adaptive installation size.

A first fixing hole 6 is provided at all four corners inside the first half bracket 1, and a second fixing hole 7 is provided at all four corners inside the second half bracket 2. The fastener includes a screw 8 and a nut 9, and the screw 8 is used to penetrate the first fixing hole 6 and the second fixing hole 7 and is fixed by the nut 9. During use, the screw 8 can be threaded through the first fixing hole 6 and the second fixing hole 7 and be fixed with a nut 9, and is used to clamp the circular tube by connecting the first half bracket 1 and the second half bracket 2.

### Embodiment 2

According to FIGS. 1, 2, and 3, the embodiment proposes a bidirectional circular tube fixing bracket, including a first half bracket 1, a second half bracket 2, and a fixing base 3, wherein the fixing base 3 is disposed at a middle position on the outer side of the first half bracket 1, and first half arc grooves 4 are provided on the inner side of the first half bracket 1 and the second half bracket 2, and the first half arc grooves 4 of the first half bracket 1 and the second half bracket 2 are matched to form the first clamping groove; second half arc grooves are provided at both ends on the inner side of the first half bracket 1 and the second half bracket 2, and the second half arc grooves 5 of the first half bracket 1 and the second half bracket 2 are matched to form the second clamping groove, rubber teeth are provided on the inner side of the first half arc groove 4 and the second half arc groove 5, and the first half bracket 1 and the second half bracket 2 are connected by fasteners. During use, the invention realizes the clamping and fixation of circular tubes through the connection between the first half bracket 1 and the second half bracket 2 by fasteners, implements the adaptive fixation of circular tubes in the first direction through the first clamping groove composed of the first half arc grooves 4 on the inner side of the first half bracket 1 and the second half bracket 2, with an adaptive size of 1.5-2 inch, and the adaptive fixation of circular tubes in the second direction through the second clamping groove composed of the second half arc grooves on the inner side of the first half bracket and the second half bracket, with an adaptive size of 1.5-2 inch, that is, the bi-directional adaptation, thus expanding the adaptive installation size.

A sleeve block 10 is provided at the middle position on the outer side of the first half bracket 1, a sleeve cover 11 is provided on one side of the fixing base 3, and the sleeve cover 11 is disposed on the outer side of the sleeve block 10. A first mounting hole 12 is provided at the middle position on one side of the sleeve block 10, a second mounting hole 13 that passes through the fixing base 3 is provided at the middle position inside the sleeve cover 11, and the first mounting hole 12 and the second mounting hole 13 are fixed internally by screws 14. A positioning hole 15 is provided at the edge of one side of the sleeve block 10, and a positioning block 16 is provided at the inner edge of the sleeve cover 11, and the positioning hole 15 is adapted to the positioning block 16. A base hole 17 is provided on the fixing base 3, and the base hole 17 is used to fix gasket and screws on the installation base surface. During use, a fixing base 3 is installed on the first half bracket 1 and is fixed on the installation base surface through a base hole 17, gaskets, and screws, so that the position of the clamped circular tube can be fixed, and the installation by screws 14 allows to remove the fixing base 3 from the first half bracket 1, fit the sleeve cover 11 with sleeve block 10, and adapt the positioning hole 15 with positioning block 16, and to install and fix the fixing base 3 after direction regulation, adapting to different installation bases in different directions.

The bidirectional circular tube fixing bracket realizes the clamping and fixation of circular tubes through the connection between the first half bracket 1 and the second half bracket 2 by fasteners, implements the adaptive fixation of circular tubes in the first direction through the first clamping groove composed of the first half arc grooves 4 on the inner side of the first half bracket 1 and the second half bracket 2, and the adaptive fixation of circular tubes in the second direction through the second clamping groove 5 composed of the second half arc grooves on the inner side of the first half bracket 1 and the second half bracket 2, that is, the bi-directional adaptation, thus expanding the adaptive installation size with wide applications. In addition, a fixing base 3 is installed on the first half bracket 1 and is fixed on the installation base surface through a base hole 17, gaskets, and screws, so that the position of the clamped circular tube can be fixed, and the installation by screws 14 allows to remove the fixing base 3 from the first half bracket 1 and adapt the positioning hole 15 with positioning block 16, and to install and fix the fixing base 3 after direction regulation, adapting to different installation bases in different directions.

The basic principles, main features, and advantages of the invention are presented and described above. Person skilled in the art should understand that the present invention is not limited by the above embodiments. The above embodiments and instructions only explain the principle of the present invention and, various changes and improvements may be made to the embodiments without departing from the spirit and scope of the present invention, all of which fall within the scope of the required protection of the invention. The scope of protection required by the present invention is defined by the attached claims and their equivalents.

What is claimed is:

1. A bidirectional circular tube fixing bracket, including a first half bracket (1), a second half bracket (2), and a fixing base (3), wherein the fixing base (3) is disposed at a middle position on the outer side of the first half bracket (1), and first half arc grooves (4) are provided on the inner side of the first half bracket (1) and the second half bracket (2), and the first half arc grooves (4) of the first half bracket (1) and the second half bracket (2) are matched to form the first clamping groove;
second half arc grooves (5) are provided at both ends on the inner side of the first half bracket (1) and the second half bracket (2), and the second half arc grooves (5) of the first half bracket (1) and the second half bracket (2) are matched to form the second clamping groove, rubber teeth are provided on the inner side of the first half arc groove (4) and the second half arc groove (5), and the first half bracket (1) and the second half bracket (2) are connected by fasteners.

2. The bidirectional circular tube fixing bracket according to claim 1, wherein a first fixing hole (6) is provided at all four corners inside the first half bracket (1), and a second fixing hole (7) is provided at all four corners inside the second half bracket (2).

3. The bidirectional circular tube fixing bracket according to claim 2, wherein the fastener includes a screw (8) and a nut (9), and the screw (8) is used to penetrate the first fixing hole (6) and the second fixing hole (7) and is fixed by the nut (9).

4. The bidirectional circular tube fixing bracket according to claim 1, wherein a sleeve block (10) is provided at the middle position on the outer side of the first half bracket (1), a sleeve cover (11) is provided on one side of the fixing base (3), and the sleeve cover (11) is disposed on the outer side of the sleeve block (10).

5. The bidirectional circular tube fixing bracket according to claim 4, wherein a first mounting hole (12) is provided at the middle position on one side of the sleeve block (10), a second mounting hole (13) that passes through the fixing base (3) is provided at the middle position inside the sleeve cover (11), and the first mounting hole (12) and the second mounting hole (13) are fixed internally by screws (14).

6. The bidirectional circular tube fixing bracket according to claim 5, wherein a positioning hole (15) is provided at the edge of one side of the sleeve block (10), and a positioning block (16) is provided at the inner edge of the sleeve cover (11), and the positioning hole (15) is adapted to the positioning block (16).

7. The bidirectional circular tube fixing bracket according to claim 6, wherein a base hole (17) is provided on the fixing base (3), and the base hole (17) is used to fix gasket and screws on the installation base surface.
